(19) United States
(12) Patent Application Publication
(10) Pub. No.: US 2005/0099080 A1
(43) Pub. Date: May 12, 2005

(54) Rotor for electric rotary machine

(75) Inventors: Akikazu Matsumoto, Anjo-shi (JP); Wataru Yagi, Nagoya-shi (JP); Naoki Kamiya, Chiryu-shi (JP); Norihiro Akita, Anjo-shi (JP); Takeshi Kamasaka, Chiryu-shi (JP)

Correspondence Address: OBLON, SPIVAK, MCCLELLAND, MAIER & NEUSTADT, P.C., 1940 DUKE STREET, ALEXANDRIA, VA, 22314, US

(73) Assignees: AISIN SEIKI KABUSHIKI KAISHA, Kariya-shi (JP); AISIN TAKAOKA CO., LTD., Aichi (JP)

(21) Appl. No.: 10/979,221

(22) Filed: Nov. 3, 2004

(30) Foreign Application Priority Data
Nov. 7, 2003 (JP) 2003-379080

(51) Int. Cl. H02K 7/00; H02K 11/00; H02K 3/46

(52) U.S. Cl. 310/156.26; 310/67 R; 310/261

(57) ABSTRACT

A rotor for an electric rotary machine includes a rotatable rotor body, a plurality of magnet portions provided at the rotor body in circumferential direction with a certain interval, and a supporting portion provided at the rotor body for supporting the plurality of the magnet portions. At least the supporting portion of the rotor body is made of ferritic cast iron as base material.

### CROSS REFERENCE TO RELATED APPLICATIONS

This application is based on and claims priority under 35 U.S.C. § 119 to Japanese Patent Application 2003-379080, filed on Nov. 7, 2003, the entire content of which is incorporated herein by reference.

### FIELD OF THE INVENTION

The present invention generally relates to a rotor. More particularly, the present invention relates to a rotor utilized for an electric rotary machine such as an electric generator or a motor.

### BACKGROUND

Conventionally, a carbon steel S10C, S15C, S25C, S45C, and SPC270, or the like, cut in a predetermined ring shape are used for forming a magnetic path portion of an outer rotor of an electric generator. In this case, a magnet portion is adhesively fastened to an inner circumferential portion of a ring portion. The magnetic path portion is generated between the magnet portion and an iron core wound by a coil. When the outer rotor is rotated in this situation, an induction current is generated at the coil wound around the iron core. Thus, electricity is generated.

Further, an outer rotor having a magnet portion provided at an inside of a ring portion made of silicon steel is known. The magnet portion is attached at an attaching hole provided at an inside of the ring portion.

A known engine generator is disclosed in U.S. Pat. No. 6,489,690B1. The engine generator includes a rotor body having an attaching portion rotated about a center of a rotational axis and a ring portion having an inner circumferential portion and an outer circumferential portion formed as a unit with the attaching portion along the center of the rotational axis, and an outer rotor having a plurality of magnetic portions supported at the inner circumferential portion of the ring portion of the rotor body in circumferential direction at a certain interval.

A known air-cooled centrifugal flywheel is disclosed in JP2002-095195A2. The air-cooled centrifugal flywheel includes a fan made of resin provided at a rotor made of cast iron having a boss portion and an attaching portion extended from the boss portion to radial direction. A magnetic portion is provided at inside of the fan made of resin.

According to U.S. Pat. No. 6,489,690B1, the outer rotor of the electric generator generates electricity by rotating the outer rotor and thus generating the induction current at the coil wound at the iron core. As described above, when the outer rotor rotates, the induction current is generated at the coil wound at the iron core, and electricity is generated. In the magnetic path described above, a core loss at the outer rotor was large, which prevented improvement of efficiency. Further, the carbon steel described above such as S1° C., S15C, S25C, S45C, SPC270, or the like, has high melting point. Therefore, manufacturing of them by casting is difficult. Then, these are processed by cutting from a block material, which increases time and cost for processing them.

According to the known art, the outer rotor having a magnet portion provided inside of the ring portion made of silicon steel is not a cast product. According to U.S. Pat. No. 6,489,690B1, an attaching portion and the ring portion of the rotor body was formed from a metallic plate bended by pressing. According to JP2002-095195A2, because the magnetic portion is buried in the fan made of resin, the fan made of resin can be effectively utilized for supporting the magnetic portion. The permeability of the resin portion surrounding the magnet portion is too low to perform yoke function, which makes efficiency of effectively using magnetic flux of the magnet portion.

A need thus exists for a rotor for an electric rotary machine, which ensures a permeability of a rotor body for supporting a magnet portion and restricts a core loss for improving performance of the electric rotary machine.

### SUMMARY OF THE INVENTION

According to an aspect of the present invention, a rotor for an electric rotary machine includes a rotatable rotor body, a plurality of magnet portions provided at the rotor body in circumferential direction with a certain interval, and a supporting portion provided at the rotor body for supporting the plurality of the magnet portions. At least the supporting portion of the rotor body is made of ferritic cast iron as base material.

### BRIEF DESCRIPTION OF THE DRAWINGS

The foregoing and additional features and characteristics of the present invention will become more apparent from the following detailed description considered with reference to the accompanying drawings, wherein:

FIG. 1 shows a cross-sectional view of an electric rotary machine according to a first embodiment of the present invention.

FIG. 2 shows a partial cross-sectional view of an outer rotor of an electric generator showing that a ring portion supports a magnet portion.

FIG. 3 shows a partial cross-sectional view from different direction of the outer rotor of the electric generator showing that a ring portion supports a magnet portion.

FIG. 4 shows a cross-sectional view of the ring portion not forming a seating groove.

FIG. 5 shows a cross-sectional view of the ring portion forming the seating groove.

FIG. 6 shows a partial cross-sectional view of the electric generator according to a second embodiment of the present invention.

FIG. 7 shows a partial cross-sectional view of a mold for forming a boundary portion the ring portion of the outer rotor with a flange portion of the outer rotor by casting according to the second embodiment of the present invention.

FIG. 8 shows a cross-sectional view of a mold for forming the ring portion of the outer rotor by casting according to a third embodiment of the present invention.

### DETAILED DESCRIPTION

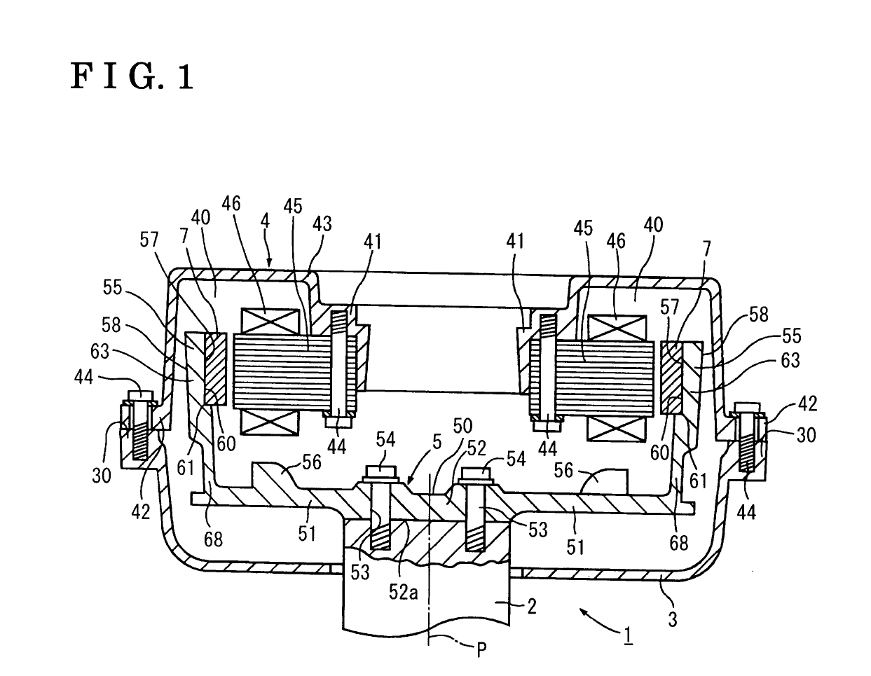

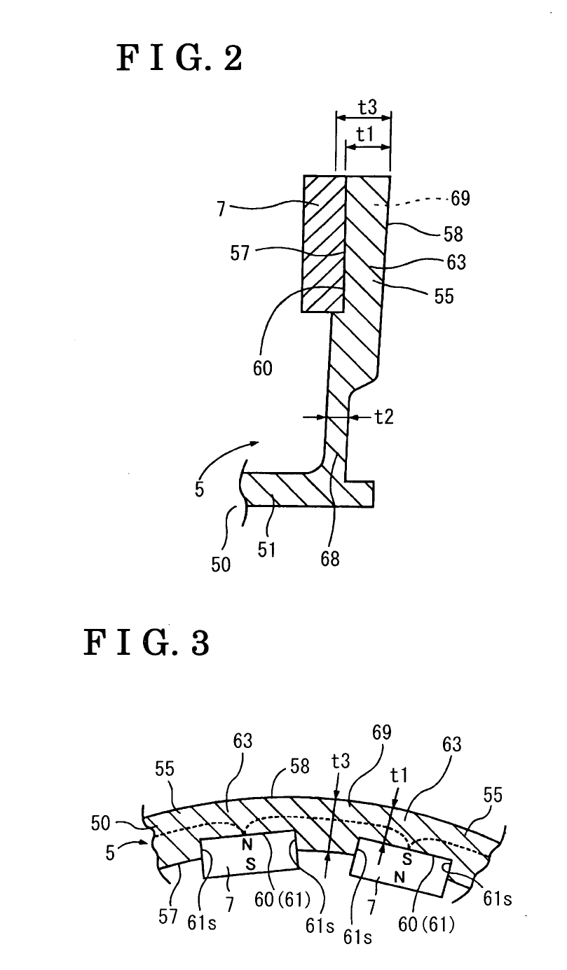

A first embodiment of the present invention will be explained with reference to the illustrations of the drawing figures as follows. FIG. 1 shows a cross-sectional view of an electric generator 1. FIG. 2 shows a cross-sectional view of a relevant part of an outer rotor 5 of the electric generator 1. As shown in FIG. 1, the electric generator 1 includes a rotational shaft 2 rotated by a drive source such as an engine (including a gas engine, a gasoline engine, and a diesel engine), a housing 3 secured to the engine to cover one end of the shaft 2, a stator 4 connected to the housing 3, and the outer rotor 5 having a function as a rotor attached to the one end of the shaft 2.

The stator 4 includes a ring chamber 40, a cover 43 having the same axis as a ring-shaped inner attaching portion 41 and a ring-shaped outer attaching portion 42, a stator core 45 made of a multi-layered silicon steel plate, the stator core 45 attached to the inner attaching portion 41 of the cover 43 by attaching bolts 44 as an attaching member, and a coil 46 coiled about the stator core 45. The stator 4 is secured to the housing 3 by connecting the outer attaching portion 42 of the cover 43 to a seating portion 30 of the housing 3 by attaching bolts 44 as an attaching member.

As shown in FIG. 1, the outer rotor 5 includes a rotor body 50 and a plurality of magnet portions 7 secured to the rotor body 50. The rotor body 50 of the outer rotor 5 includes a flange portion 51 secured to the one end of the shaft 2 and rotated about a rotational axis P of the shaft 2, the flange portion 51 serving as an attaching portion, and a ring portion 55 provided at an outer circumferential portion of and coaxially with and integrally with the flange portion 51. The flange portion 51 is disc-shaped and can serve as a connecting portion for connecting the shaft 2 and the ring portion 55. Boss portions 52 having inserting holes 53 are provided at around a center portion of the flange portion 51. The boss portions 52 of the flange portion 51 of the outer rotor 5 are attached to the one end of the shaft 2 in attachable/detachable way by attaching bolts 54 serving as an attaching member inserted to the inserting holes 53 of the boss portions 52. Each boss portion 52 has a contacting surface 52a contacting with the one end of the shaft 2. Each boss portion 52 is thicker than the other portion of the flange portion 51 for reinforcement. The thicker boss portions 52 can increase weight of the outer rotor 5, which gives flywheel effect of the outer rotor 5.

The ring portion 55 of the outer rotor 5 is cantilevered at the flange portion 51. The ring portion 55 of the outer rotor 5 includes an inner circumferential portion 57 and an outer circumferential portion 58 extended in parallel with the rotational axis P of the shaft 2. As shown in FIG. 3, the inner circumferential portion 57 of the ring portion 55 includes a seating groove 61 having a seating surface 60 formed by a cutting process. The outer circumferential portion 58 of the ring portion 55 may be a black skin or a surface formed by the cutting process. As shown in FIG. 1, a plurality of fin portions 56 for generating wind for cooling is provided in circumference direction of the flange portion 51 at its side opposing to the stator core 45 at a certain interval.

As shown in FIG. 3, the plurality of the magnet portions 7 include a plurality of permanent magnets provided in circumference direction of the ring portion 55 and supported at its inner circumferential portion 57 at a certain interval. The magnet portions 7 are made of, but not limited to, neodymium series or samarium series material, or the like. As shown in FIG. 3, the plurality of seating grooves 61 each having the seating surface 60 is provided in circumference direction of the ring portion 55 of the outer rotor 5 at its inner circumferential portion 57 at the certain interval and made by cutting process. Each magnet portion 7 is fastened to each seating groove 61 by adhesive, or the like. As shown in FIG. 3, side surfaces 61s of each seating groove 61 engage with each magnet portion 7. This engaging portion has enough adhesion force to countervail a centrifugal force applied from the rotating rotor body 50 in radial direction. Thus, detachment of the magnet portion 7 caused by centrifugal force can be prevented even when the outer rotor 5 is rotated at high speed.

In FIG. 1, the whole rotor body 50 is formed from molten metal to be ferritic cast iron by casting with a mold. At least a supporting portion 63 for supporting and opposing to the plurality of the magnet portions 7 at the inner circumferential portion 57 of the ring portion 55 of the rotor body 50 is made of the ferritic cast iron as base material. In other words, at least the ring portion 55 of the outer rotor 5 is made of the ferritic cast iron as base material.

The ferritic cast iron has a ferritic matrix. Ferrite is an iron containing a small amount of diffused carbon, which is similar amount of carbon of pure iron. Therefore, ferrite has good magnetic property and high permeability in nature. The ferritic cast iron has ferrite area ratio equal to or greater than 40% in the matrix. Therefore, it is preferable that the ferritic cast iron has ferrite area ratio equal to or greater than 60%, equal to or greater than 80% when considering the matrix as 100%. Further, it is preferable that the ferritic cast iron has ferrite area ratio equal to or greater than 90%, equal to or greater than 95% when considering the matrix as 100%. It is preferable that the ferritic cast iron has ferrite area ratio substantially 100% considering the matrix as 100%. The larger ferrite area ratio becomes, the richer the amount of ferrite of the ferritic cast iron becomes. Thus, composition of the matrix becomes close to pure iron, which improves permeability of the ferritic cast iron.

Ferrite area ratio indicates an area ratio occupied by ferrite in 2-dimensional cross-sectional surface of the matrix. The matrix does not include an area of graphite. The matrix does not include graphite and carbide in case that both graphite and carbide (not including cementite and pearlite) are formed. Accordingly, in case that carbide such as vanadium carbide, tungsten carbide, molybdenum carbide, and titanium carbide are formed simultaneous with graphite, an area of these carbides and graphite are subtracted from a viewing area. A remaining area is considered as the matrix. Ferrite area ratio indicates the area occupied by ferrite in the matrix considered as 100%.

The ferritic cast iron includes an cast iron without cementite and pearlite, and with partially formed cementite and pearlite, as long as the ferritic cast iron contains ferrite equal to or greater than 40%. When the ferritic cast iron is chilled, heat treatment is possible for the ferritic cast iron by being heated and maintained at high temperature (generally equal to or higher than 700° C., equal to or lower than 1200° C.). By the heat treatment, ferrite area ratio of the ferritic cast iron can be increased, which improves magnetic property of the ferritic cast iron.

Ferrite area ratio of the supporting portion 63 of the rotor body 50 can be higher than that of the other portion of the rotor body 50. By this, permeability of the supporting portion 63 for supporting the magnetic portions 7 can be increased, which increases yoke function of the supporting portion 63.

At least the supporting portion 63 of the ring portion 55 of the rotor body 50 for supporting the magnetic portions 7 is made of the ferritic cast iron as a base material. In this case, permeability of the supporting portion 63 for supporting the magnetic portions 7 can be increased, which increases yoke function of the supporting portion 63. It is preferable that ferrite area ratio of the supporting portion 63 is set to be higher than that of a boundary portion 68 of the ring portion 55 of the rotor body 50 with the flange portion 51 of the rotor body 50. In order to increase permeability of the supporting portion 63, it is preferable that the supporting portion 63 contains a small amount of or does not contain pearlite. Accordingly, it is preferable that pearlite area ratio of the boundary portion 68 is set to be higher than that of the supporting portion 63. Pearlite area ratio indicates an area ratio occupied by pearlite in 2-dimensional cross-section of the matrix. Pearlite area ratio is obtained by similar method to that of ferrite described above. Permeability of pearlite is smaller than that of ferrite. Further, pearlite has magnetic resistance. Therefore, it is expected that pearlite can take a role of a magnetic resistance portion, which contributes to reduce a leakage of magnetic flux.

Further, it is preferable that cementite area ratio of the boundary portion 68 of the ring portion 55 of the rotor body 50 with the flange portion 51 of the rotor body 50 is set to be higher than that of the supporting portion 63 of the ring portion 55 of the rotor body 50. Cementite area ratio indicates an area ratio occupied by cementite in 2-dimensional cross-section of the matrix. Cementite area ratio is obtained by similar method to that of ferrite described above. Permeability of cementite is smaller than that of ferrite and pearlite. Further, cementite has magnetic resistance. Therefore, it is expected that cementite can take a role of a magnetic resistance portion, which contributes to reduce a leakage of magnetic flux. In addition, it is preferable that cementite is not formed at the supporting portion 63 of the ring portion 55 of the rotor body 50 for supporting the magnet portions 7 in order to increase yoke function of the supporting portion 63 of the ring portion 55 of the rotor body 50.

Ferrite area ratio at the supporting portion 63 of the ring portion 55 of the rotor body 50 is set to be equal to or greater than 40%, which improves permeability of the supporting portion 63 and magnetic flux density.

As described above, the ring portion 55 of the rotor body 50 is expected to have yoke function. The boss portion 52 and the flange portion 51 of the rotor body 50, however, are not expected to have yoke function. Therefore, it is preferable that ferrite area ratio of the boss portion 52 and the flange portion 51 of the rotor body 50 is reduced and pearlite area ratio and cementite area ratio thereof are increased.

In the embodiment, ferrite area ratio of the ring portion 55 of the rotor body 50 is set to be higher than that of the boundary portion 68 of the ring portion 51 of the rotor body 50 with the flange portion 51 of the rotor body 50. In other words, when ferrite area ratio of the ring portion 55 is set to be equal to or greater than 85%, ferrite area ratio of the boundary portion 68 is set to be less than 85%. Further, when ferrite area ratio of the ring portion 55 is set to be equal to or greater than 90%, ferrite area ratio of the boundary portion 68 is set to be less than 90%.

Ferrite area ratio of the ring portion 55 of the outer rotor 5 is generally set to be equal to or greater than 90%, equal to or greater than 95%. On the other hand, ferrite area ratio of the boundary portion 68 of the ring portion 55 of the rotor body 50 with the flange portion 51 of the rotor body 50 is set to be from 0% to less than 70%. In other words, pearlite area ratio of the boundary portion 68 is set to be greater than that of the ring portion 55. Pearlite has larger magnetic resistance and lower permeability. Thus, pearlite can function as a magnetic resistance portion. Increase in pearlite area ratio of the boundary portion 68 restrains that magnetic flux at the ring portion 55 leaks through the boundary portion 68 to the flange portion 51 side, which can reduce the leakage of magnetic flux. Accordingly, it is advantageous for forming good magnetic path at the ring portion 55, which can improve electric generation efficiency.

In FIG. 2, an average thickness t1 of the supporting portion 63 of the ring portion 55 for supporting and opposing the magnet portions 7 is set to be thicker than an average thickness t2 of the boundary portion 68 of the ring portion 55 of the rotor body 50 with the flange portion 51 of the rotor body 50. Thick portion has smaller cooling rate in casting process than that of thin portion. Therefore, ferrite area ratio of the supporting portion 63 can be increased. Accordingly, permeability of the supporting portion 63 for supporting the magnet portion 7 is further improved, which improves magnetic flux density. Further, in FIG. 3, an average thickness t3 of a portion 69 of the ring portion 55 not opposing and not supporting the magnet portions 7, is thicker than the average thickness t1 of the supporting portion 63. Thus, ferrite area ratio and permeability of the portion 69 transmitting magnetic flux can be increased.

The ferritic cast iron forming the ring portion 55 of the rotor body 50 includes a lot of diffused graphite. The graphite is composed of at least any one of spheroidal graphite, compacted vermicular graphite, graphite flakes, lump graphite, multiform graphite, rosette form graphite, and eutectic graphite. Graphite has larger specific resistance than that of the ferritic matrix. Therefore, the graphite can circumvent an eddy current, which can reduce an eddy current loss and core loss. Spheroidal graphite, compacted vermicular graphite, lump graphite, and mutiform graphite, or the like, are advantageous to increase specific resistance and reduce the core loss, and are effective to ensure strength. Flake graphite has a large graphite length, which can highly circumvent the eddy current.

Spheroidal graphite indicates spheroidal graphite and approximately spheroidal graphite formed in molten metal spheroidized by spheroidizing agent. In case that element for producing carbide, such as vanadium, or aluminum are added to the molten metal, the molten metal can be insufficiently and unsatisfactory spheroidized, which reduces spheroidized ratio of spheroidal graphite even when the molten metal is spheroidized by the spheroidizing agent. Compacted vermicular graphite is also called as vermicular-shaped graphite. Multiform graphite (random-shaped graphite) is randomly shaped graphite, which generally indicates graphite insufficiently spheroidized when the molten metal is spheroidized by the spheroidizing agent. Distinction between multiform graphite and lump graphite is sometimes difficult.

A composition of the ferritic cast iron can be selected by considering about required permeability, required strength, or the like, ranging silicon 1.0-12% by weight, carbon 1.8-4.6% by weight. Generally, the ferritic cast iron contains silicon 2-5% by weight and carbon 2.0-4.0% by weight.

The ferritic cast iron can contain boron or aluminum or combination thereof. When boron is contained in the ferritic cast iron, iron-boron series compounds, iron-boron-carbon series compounds are formed in grain boundary of the ferritic matrix, which has advantage to reduce core loss. The amount of boron contained in the ferritic cast iron can be equal to or less than 2% by weight, equal to or less than 1% by weight at upper limit. The amount of boron contained in the ferritic cast iron is exampled as equal to or less than 0.5% by weight, equal to or less than 0.1% by weight. The amount of boron contained in the ferritic cast iron can be exampled as equal to or greater than 0.001% by weight, equal to or greater than 0.01% by weight at lower limit. Accordingly, the amount of boron contained in the ferritic cast iron can be exampled as 0.01-2% by weight, 0.01-1% by weight.

The ferritic cast iron containing aluminum has advantage to ensure magnetic flux density and reduce core loss. The amount of aluminum contained in the ferritic cast iron can be exampled as equal to or less than 8% by weight at upper limit. The amount of aluminum contained in the ferritic cast iron can be exampled as equal to or less than 6% by weight, equal to or less than 5% by weight. The amount of aluminum contained in the ferritic cast iron can be exampled as equal to or greater than 0.005% by weight, equal to or greater than 0.01% by weight at lower limit. Accordingly, the amount of aluminum contained in the ferritic cast iron can be exampled as 0.005-8% by weight, 0.01-6% by weight.

The ferritic cast iron can contain carbide produced by element for producing carbide and diffused in the ferritic matrix. The element for producing carbide consumes carbon contained in the ferritic matrix to produce carbide, which reduces the amount of carbon in the ferritic matrix. Accordingly, a composition of the ferritic matrix becomes close to that of pure iron, which improves permeability and magnetic flux density. Carbide can be grain-shaped. The Grain-shaped carbide ensures strength. The grain-shaped carbide restrains cracking of the ferritic cast iron, which can contribute to long-life of products made of the ferritic cast iron even under strict condition. It is preferable that a size of the carbide is equal to or less than 100 μm in average. The carbide having the size described above can contribute to long life of products made of the ferritic cast iron even under strict condition. The carbide described above can be equal to or smaller than 80 μm, equal to or smaller than 50 μm, equal to or smaller than 40 μm in an average grain size. The carbide described above can be equal to or larger than 1 μm in the grain size at lower limit.

The element for producing carbide, such as vanadium or the like, can be contained equal to or less than 8% by weight in the ferritic cast iron as 100%. The element for producing carbide, such as vanadium or the like, can be contained equal to or less than 7% by weight, equal to or less than 6% by weight, equal to or less than 4% by weight at upper limit. Further, the element for producing carbide, such as vanadium or the like, can be contained equal to or less than 3% by weight, equal to or less than 2% by weight at upper limit. The element for producing carbide, such as vanadium or the like, can be contained equal to or greater than 0.1% by weight, equal to or greater than 0.2% by weight, equal to or greater than 0.3% by weight at lower limit. Accordingly, the amount of the contained element for producing carbide can be exampled as, but not limited to, 0.1-6% by weight, 0.2-4% by weight, 0.3-3% by weight.

The element for producing carbide can include at least one of vanadium, tungsten, molybdenum, and titanium. The carbide can include at least one of vanadium carbide, tungsten carbide, molybdenum carbide, and titanium carbide. In this case, the element for producing carbide such as vanadium, tungsten, molybdenum, and titanium, or the like, consumes carbon contained in the ferritic matrix, which reduces the amount of carbon in the ferritic matrix. Therefore, composition of the ferritic matrix becomes close to that of pure iron, which improves permeability and magnetic flux density.

The ferritic cast iron can contains silicon 1.0-12% by weight and carbon 1.5-4.6% by weight. Silicon contained in the ferritic cast iron promotes ferrite producing, which increases permeability of the ferritic cast iron. Excessive amount of silicon, however, increases hardness of the ferritic cast iron, which makes processing difficult in case that the ferritic cast iron is processed by such as cutting process, or the like. In addition, the excessive amount of silicon degrades fluidity of molten metal of the ferritic cast iron, which tends to degrades castability. The amount of silicon can be larger in a range that silicon does not cause degradation of process ability and castability. As above considered, the amount of silicon can be exampled as, but not limited to, equal to or greater than 1.1% by weight, equal to or greater than 1.2% by weight, equal to or greater than 1.3% by weight at lower limit. The amount of silicon can be exampled as, but not limited to, equal to or less than 4% by weight, equal to or less than 5% by weight, equal to or less than 6% by weight at upper limit. Further, the amount of silicon can be exampled as, but not limited to, equal to or less than 8% by weight, equal to or less than 10% by weight at upper limit. Accordingly, the amount of silicon can be exampled as 1.1-11% by weight, 1.2-8% by weight, 1.2-6% by weight.

As above described, silicon promotes to produce ferrite and increases permeability of the ferritic cast iron as an iron cast series soft magnetic material. The amount of silicon by weight can be substantially equal to or greater than the amount of carbon by weight. Accordingly, a ratio of the amount of silicon by weight to that of carbon by weight (Si/C) can be exampled as equal to or greater than 0.95, equal to or greater than 1, equal to or greater than 1.2, equal to or greater than 1.8, and equal to or less than 2.0. When the soft magnetic material is formed from a multi-layered silicon steel plate, larger amount of silicon causes the harder silicon steel plate, which degrades availability of blanking of pressing process. On the other hand, for iron cast formed by solidified molten metal, it is not needed to consider an availability of blanking of pressing process.

Carbon contained in molten metal lowers a starting temperature of solidification of the molten metal, which improves fluidity of the molten metal and castability. Excessive amount of carbon, however, degrades permeability. Then, preferably, the amount of carbon can be exampled as 1.5-4.6% by weight. In this case, the amount of carbon can be exampled as, but not limited to, equal to or greater than 1.8% by weight, equal to or greater than 1.9% by weight, equal to or greater than 2.0% by weight at lower limit. The amount of carbon can be exampled as, but not limited to, equal to or less than 4.3% by weight, equal to or less than 4.0% by weight, equal to or less than 3.8% by weight, equal to or less than 3.6% by weight at upper limit. Accordingly, the amount of carbon can be exampled as, but not limited to, 1.5-4.6% by weight, 1.6-4.2% by weight, 1.8-4.0% by weight, 1.8-3.8% by weight.

It is preferable that the cast iron series soft magnetic material contains the amount of carbon and silicon equal to or greater than 2 in carbon equivalent value (CE value). By this, the cast iron series soft magnetic material having good castability and magnetic property can be obtained. Carbon equivalent is given by (equation 1).
Carbon equivalent=the amount of carbon (weight %)+the amount of silicon (weight %)×⅓ (equation 1)

The ferritic cast iron related to the present invention can be used either after heat treatment or without heat treatment. Ferrite area ratio can be increased by heat treatment. When used without heat treatment, for ensuring ferrite area ratio, the ferritic cast iron can be made of a material with controlled composition so as to have high carbon equivalent value. Carbon equivalent value varies by with or without heat treatment, a kind of application of the iron series soft magnetic material, a kind of material, the amount of the other alloying element, required strength, and cost. The carbon equivalent value can be exampled as equal to or greater than 2.2, equal to or greater than 2.5, equal to or greater than 3 at lower limit. The carbon equivalent value can be exampled as equal to or less than 6, equal to or less than 5.5 at upper limit. Accordingly, the ferritic cast iron may be any of hypoeutectic, eutectic, and hypereutectic.

As mentioned above, according to the embodiment of the present invention, at least the supporting portion 63 of the ring portion 55 for supporting the magnet portion 7 is made of the ferritic cast iron as a base. In other words, at least the ring portion 55 of the outer rotor 5 is made of the ferritic cast iron as a base. The ring portion 55, especially the supporting portion 63 for supporting the magnet portions 7 can be utilized as a yoke for transmitting magnetic flux from the magnet portions 7, which is advantageous to form magnetic path and improve the efficiency of electric generation. Ferrite area ratio of the ring portion 55 is set to be higher than that of the boundary portion 68 of the ring portion 55 of the rotor body 50 with the flange portion 51 of the rotor body.

Further, as mentioned above, graphite diffused in the ferritic cast iron has higher specific resistance than that of the ferritic matrix enough to circumvent eddy current, which can contribute to reduce eddy current loss and core loss. Accordingly, the efficiency for generating electricity can be improved.

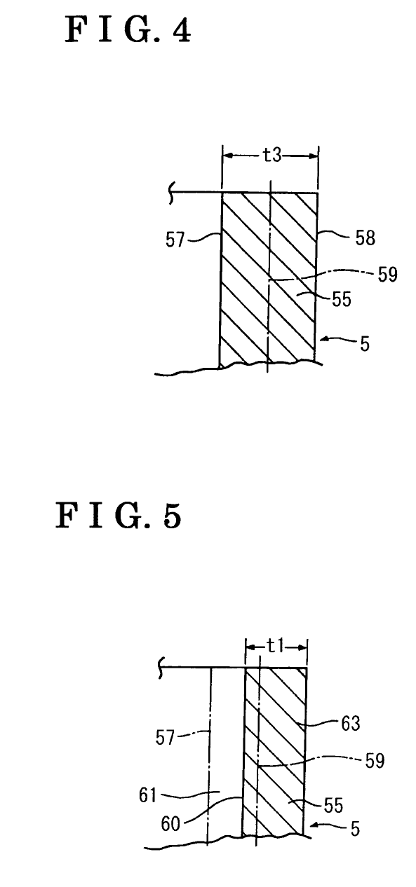

According to the embodiment of the present invention, the outer rotor 5 is made of cast iron formed from solidified molten metal. In this case, a cooling rate of the ring portion 55 of the outer rotor 5 is faster at the inner circumferential portion 57 and the outer circumferential portion 58 than at a center portion 59 in thickness direction shown in FIG. 4. Therefore, ferrite area ratio becomes smaller at the inner circumferential portion 57 of the ring portion 55 than at the center portion 59 of the ring portion 55 in thickness direction. This is not preferable for obtaining high permeability at the magnet portions 7 side of the ring portion 55.

Then, in this embodiment, as shown in FIG. 5, as mentioned above, the inner circumferential portion 57 of the ring portion 55 of the outer rotor 5 is cut for forming the seating groove 61 having the seating surface 60. The seating surface 60 of the seating groove 61 is positioned at the inside of the ring portion 55 in thickness direction from the center portion 59 having rich ferrite and good permeability, in other words, close to the center portion 59. Therefore, ferrite area ratio around the seating surface 60 becomes high. Accordingly, the supporting portion 63 for supporting the magnet portions 7 can be further efficiently utilized as a yoke for transmitting magnetic flux, which can improve efficiency for electric generation. Further, the outer rotor 5 according to the embodiment of the present invention can be used with or without heat treatment. Heat treatment, in other words heating and maintaining the cast iron at A1 transformation temperature, further increases ferrite area ratio of the cast iron.

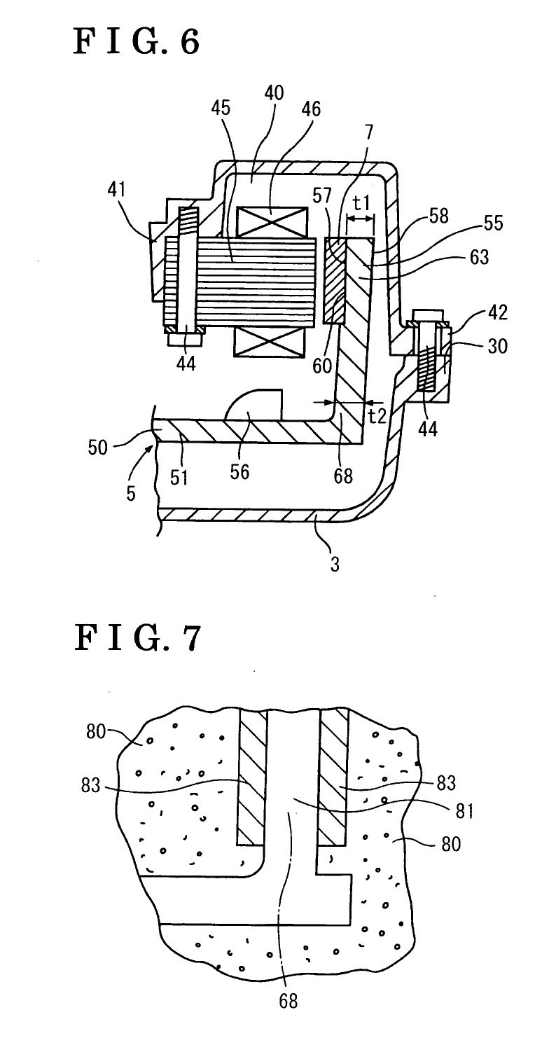

A second embodiment of the present invention will be explained with reference to illustrations of the drawing figures as follows. FIG. 6 shows a relevant part of the second embodiment of the present invention. This embodiment has basically the same structure, action and effect as the first embodiment previously mentioned. Differences from the first embodiment will be mainly explained as follows. According to the embodiment of the present invention, the average thickness t2 of the boundary portion 68 of the ring portion 55 of the rotor body 50 with the flange portion 51 of the rotor body 50 is thickened for obtaining strength. The average thickness t2 of the boundary portion 68 is close to or thicker than the average thickness t1 of the supporting portion 63 for supporting the magnet portions 7. In this case, when casting the outer rotor 5 by a mold, as shown in FIG. 7, it is preferable that a chilling element 83 such as a chiller is provided opposing to or being close to a cavity portion 81 of the mold 80 for forming the boundary portion 68. Thus, a cooling rate of the boundary portion 68 can be increased. Therefore, the area ratio of pearlite and cementite functioning as magnetic resistance portion can be increased at the boundary portion 68. Accordingly, the boundary portion 68 can function as magnetic resistance portion well and simultaneously strength of the boundary portion 68 can be increased by thickening the boundary portion 68. Therefore, a leakage of magnetic flux from the ring portion 55 to the flange portion 51 side can be restrained, which can reduce the leakage of magnetic flux.

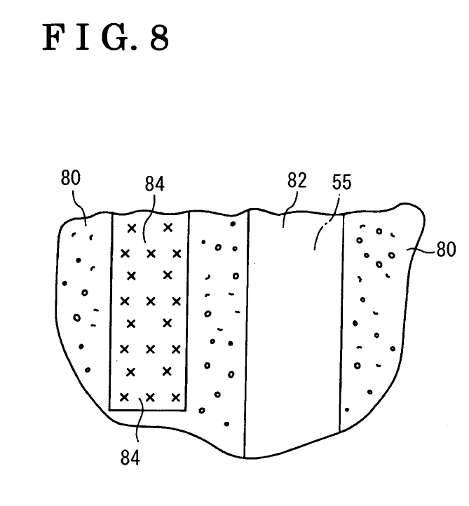

A third embodiment of the present invention will be explained with reference to the illustrations of the drawing figures. FIG. 8 shows a relevant part of the third embodiment of the present invention. The embodiment has basically same structure, action, and effect of the first embodiment previously mentioned. Differences from the first embodiment will be mainly explained as follows. It is preferable that a cooling rate of the ring portion 55 of the outer rotor 5 is low for increasing ferrite area ratio when casting. In this embodiment, as shown in FIG. 8, an element 84 for decreasing the cooling rate is provided around the cavity portion 82 of the mold 80 serving as a forming mold for forming the ring portion 55. A heat insulating material having higher heat resistance than that of the mold 80, thermal storage medium, heating element, or the like, can be employed as the element 84 for decreasing the cooling rate.

A test example 1 will be explained as follows. Highly pure pig iron 6 kg by weight (containing carbon 4.0% by weight), steel (S10C) 19 kg by weight, recarburizer 1080 g by weight (containing carbon 70% by weight), and ferrosilicon 1800 g by weight (containing silicon 70% by weight) were weighed and melted in a high frequency melting furnace at 1450-1600° C. Molten metal was used for forming a test sample by casting.

Then, spheroidizing agent 350 g by weight (TDCR-5 containing magnesium 4.8% by weight, silicon 46% by weight, calcium 2.4% by weight, and balance iron manufactured by Toyo Denka Kogyo) and ferrosilicon 70 g by weight (containing 70% silicon by weight and balance iron) were contained in a crucible, and covered with iron fillings. The molten metal at 1600° C. was poured into the crucible containing above mentioned spheroidizing agent to be spheroidized. After that, the spheroidized molten metal was poured into a cavity of a mold as a forming mold (a self-hardening sand mold, in which alkali phenol was used as binder). At this time, a pouring temperature of the molten metal was at 1450° C. When the molten metal was poured, inoculant (iron-silicon series) was added. Predetermined time (1 hour) after the molten metal was poured into the mold, the mold was broken for bringing out a solidified cast. The test sample was formed from the cast by cutting process. The test sample was used without heat treatment.

Thus, a cast iron series soft magnetic material made of spheroidal graphite cast iron containing carbon 3.3% by weight, silicon 4.9% by weight, balance iron, and inevitable impurity was formed. The cast iron series soft magnetic material contains manganese about 0.2-0.6% by weight, inevitable phosphorous and sulfur. The cast iron series soft magnetic material is the ferric cast iron with spheroidal graphite diffused in the ferric matrix containing silicon.

Ring-shaped test sample (outer diameter 36 mm, inner diameter 19 mm, height 10 mm) for a measurement of magnetic property was cut off from the above mentioned iron cast series soft magnetic material by cutting process. The test sample was annealed (at 1000° C., in 5 hours). Alternating current magnetic property of the test sample was measured. The test sample was wound by coil in 200 turns for forming an exciting coil, 50 turns for forming a detecting coil. Saturation flux density (mT) and core loss (kW/m³) of the test sample are measured in condition of 10000 A/m in magnetic field and 240 Hz in alternating current frequency, by a B-H analyzer (SY-8232 manufactured by Iwasaki Tsushinki) as a measuring apparatus. Variation of value of the magnetic property measured by the measuring apparatus at the alternating current measurement was within 1%. The basically same measurement condition as mentioned above was applied to another test examples (containing vanadium, aluminum, boron, or the like). Further, carbon steel S15C, S25C, S45C as comparative examples were tested similarly.

Test results are shown in (Table 1).

TABLE 1

| | Saturation | Core loss |
|---|---|---|
| | flux density mT | kW/m³ |
| Test example 1 | 1253 | 1746 |
| (C: 3.3%, Si: 4.9%) | | |
| Comparative example 1 (S15C) | 1195 | 6571 |
| Comparative example 2 (S25C) | 1231 | 6790 |
| Comparative example 3 (S45C) | 1219 | 6798 |

Regarding to the above mentioned electric generator, considering required property of the outer rotor 5 of the electric generator 1 having 260 volt at three phase and 16 poles, it is preferable that saturation flux density is equal to or greater than 1200 mT and core loss is equal to or less than 5000 kW/m³ per unit volume.

As shown in (Table. 1), the test sample based on the first embodiment showed 100% ferrite area ratio, 1253 mT in saturation flux density Bm, and 1746 kW/m³ in core loss per unit volume. In other words, the test sample based on the first embodiment showed good performance ensuring saturation flux density and showing low core loss. On the other hand, a comparative example 1 showed 1195 mT in saturation flux density Bm and comparatively high core loss, 6571 kW/m³. A comparative example 2 showed 1231 mT in saturation flux density Bm and comparatively high core loss, 6790 kW/m³. A comparative example 3 showed 1219 mT in saturation flux density Bm and comparatively high core loss, 6798 kW/m³.

A test example 2A will be explained as follows. Highly pure pig iron, steel, recarburizer, and ferrosilicon are weighed, and melted at a high frequency furnace at 1450-1600° C. Molten metal was used for forming a test sample by casting. Then, spheroidizing agent 330 g by weight (containing manganese 4.8% by weight, silicon 46% by weight, calcium 2.4% by weight, and balance iron) and ferrosilicon 70 g by weight (containing silicon 70% by weight and balance iron) were contained in a crucible, and covered with iron fillings. The molten metal at 1600° C. was poured to the crucible containing the spheroidizing agent described above to be spheroidized. After that, the spheroidized molten metal was poured into a cavity of a mold as a forming mold (a self-hardening sand mold, alkali phenol is used as binder). At this time, a pouring temperature of the molten metal was at 1450° C. When the molten metal was poured, inoculant (iron-silicon series) was added to the molten metal. Predetermined time (1 hour) after the molten metal was poured into the mold, the mold was broken for bringing out a solidified cast. The test sample was formed similarly as described above. The test sample was used without heat treatment.

Thus, the cast iron series soft magnetic material containing 2.0% by weight of carbon, 3.0% by weight of silicon, 0.07% by weight of boron, and residual substantially composed of iron, and inevitable impurities was formed. The cast iron series soft magnetic material includes compacted vermicular graphite (CV graphite) diffused in the ferritic matrix. In this case, the cast iron series soft magnetic material has about 95% of the ferrite area ratio, 1446 mT in saturation flux density Bm, 1880 kW/m³ in core loss per unit volume.

A test example 2B will be explained as follows. The cast iron series soft magnetic material containing carbon 2.3% by weight, silicon 3.4% by weight, boron 0.03% by weight, and residual composed of substantially iron and inevitable impurities was made by similar method to that of the test example 2A. This cast iron series soft magnetic material includes compacted vermicular graphite (CV graphite) diffused in the ferritic matrix. In this case, the cast iron series soft magnetic material has about 96% in ferrite area ratio, and showed 1441 mT in saturation flux density Bm and 1866 kW/m³ in core loss per unit volume. Thus, the saturation flux density was ensured and the core loss was decreased.

A test example 2C will be explained as follows. A cast iron series soft magnetic material containing carbon 3.5% by weight, silicon 5.0% by weight, boron 0.05% by weight, and residual composed of substantially iron and inevitable impurities was made by similar method. According to test results, the cast iron series soft magnetic material showed about 95% in ferrite area ratio, 1477 mT in saturate flux density Bm, and 1336 kW/m³ in core loss per unit volume. Thus, according to the test results, the saturation flux density was ensured and the core loss was decreased.

A test example 3A will be explained as follows. In the test example 3A, vanadium was added as an element for producing carbide. At first, highly pure pig iron, steel, recarburizer, ferrosilicon, and ferrovanadium (FeV) were weighed and melted at a high frequency melting furnace at 1450-1600° C. Molten metal was used for forming a test sample by casting. Then, spheroidizing agent 350 g by weight (containing manganese 4.8% by weight, silicon 46% by weight, calcium 2.4% by weight, and balance iron) and ferrosilicon 70 g by weight (containing silicon 70% by weight and balance iron) were contained in a crucible covered with iron fillings. The molten metal at 1600° C. was poured into the crucible containing the spheroidizing agent to be spheroidized. After that, the spheroidized molten metal was poured into a cavity of a mold as a forming mold (a self-hardening sand mold, alkali phenol was used as binder). At this time, a pouring temperature of the molten metal was at 1450° C. When the molten metal was poured, inoculant (iron-silicon series) was added. Predetermined time (1 hour) after the molten metal was poured into the mold, the mold was broken for bringing out a solidified cast. The test sample is used without heat treatment.

A cast iron series soft magnetic material including carbon 3.6% by weight, silicon 4.87% by weight, vanadium 2.03% by weight as an element for producing carbon, and residual composed of substantially iron, and inevitable impurities was made by the method above mentioned. The cast iron series soft magnetic material includes manganese about 0.2-0.6% by weight, inevitable phosphorous, and sulfur. In this case, the cast iron series soft magnetic material showed 95% in ferrite area ratio, 1482 mT in saturation flux density Bm, and 1621 kW/m³ in core loss per unit volume. Thus, the saturation flux density was ensured and the core loss was decreased.

In this case, not only spheroidal graphite, but also multiform graphite caused by insufficient spheroidizing and formed from broken spheroidal graphite was formed in the ferritic matrix. Because the iron cast soft magnetic material contains vanadium, even when processed by spheroidizing, the iron cast soft magnetic iron tends to show lower spheroidized ratio. It is assumed that the multiform graphite contributes to increase circumvent of eddy current. Further, granular vanadium carbide having an average particle diameter equal to or less than 30 μm was formed and diffused in the ferritic matrix. It is assumed that vanadium as element for producing carbide consumes carbon contained in the ferritic matrix to produce vanadium carbide, therefore the amount of carbon in the ferritic matrix is reduced, and a composition of the ferritic matrix becomes much similar to the composition of pure iron, which improves permeability and saturation flux density.

A test example 3B will be explained as follows. A cast iron series soft magnetic material containing carbon 2.11% by weight, silicon 3.91% by weight, vanadium 0.99% by weight, and residual composed of substantially iron and inevitable impurities was made by similar method to the test example 3A. According to test results, the cast iron series soft magnetic material showed about 100% in ferrite area ratio, 1502 mT in saturation flux density Bm, and 2237 kW/m³ in core loss per unit volume. Thus, the saturation flux density was ensured and the core loss was decreased.

A test example 3C will be explained as follows. A cast iron series soft magnetic material containing carbon 2.0% by weight, silicon 1.5% by weight, vanadium 0.49% by weight, and residual composed of substantially iron and inevitable impurities was made by similar method to the test example 3A. According to test results, the cast iron series soft magnetic material showed about 99% in ferrite area ratio, 1532 mT in saturation flux density Bm, and 2734 kW/m³ in core loss per unit volume. Thus, according to the test results, the saturation flux density was ensured and the core loss was decreased.

A test example 3D will be explained as follows. A cast iron series soft magnetic material containing carbon 2.01% by weight, silicon 1.66% by weight, vanadium 0.535% by weight, boron 0.05% by weight, and residual composed of substantially iron and inevitable impurities was made by similar method to the test example 3A. In this case, ferroboron (FeB) powder was added to the molten metal with ferrosilicon when adding inoculant. According to the test result, the cast iron series soft magnetic material showed about 99% in ferrite area ratio, 1542 mT in saturation flux density Bm, and 2261 kW/m³ in core loss per unit volume. According to the test results, thus, the saturation flux density was ensured and the core loss was decreased.

A test example 4A will be explained as follows. In the test example 4A, ferrite area ratio was restrained and aluminum was added. At first, highly pure pig iron, steel, recarburizer, and ferrosilicon are weighed, and melted at a high frequency melting furnace at 1450-1600° C. Molten metal was used for forming a test sample by casting. Then, spheroidizing agent 350 g by weight (containing manganese 4.8% by weight, silicon 46% by weight, calcium 2.4% by weight, and balance iron) and ferrosilicon 70 g by weight (containing silicon 70% by weight and balance iron) are contained in a crucible, and covered with iron fillings. The molten metal at 1600° C. was poured into the crucible containing the spheroidizing agent as described above and spheroidized. After that, the spheroidized molten metal was poured into a cavity of a mold as a forming mold (a self-hardening sand mold, alkali phenol was used as binder). At this time, a pouring temperature of the molten metal was at 1450° C. When the molten metal was poured, inoculant (iron-silicon series) was added to the molten metal. Predetermined time (1 hour) after, the mold was broken for bringing out a solidified cast. The test sample is used without heat treatment.

An cast iron series soft magnetic material containing carbon 2.47% by weight, silicon 2.78% by weight, aluminum 1.84% by weight, and residual composed of substantially iron and inevitable impurities was made by above mentioned method. The cast iron series soft magnetic material contains manganese about 0.2-0.6% by weight and inevitable phosphorous and sulfur. In this case, spheroidal graphite and compacted vermicular graphite (CV graphite) were formed and diffused in the ferritic matrix. According to the test result, the cast iron showed about 43% in ferrite area ratio, 1404 mT in saturation flux density Bm, and 1392 kW/m³ in core loss per unit volume.

A test example 4B will be explained as follows. A cast iron series soft magnetic material containing carbon 2.55% by weight, silicon 2.68% by weight, aluminum 0.90% by weight, and residual composed of substantially iron and inevitable impurities was made by similar method to the test example 4A. According to test results, the cast iron series soft magnetic material showed about 40% in ferrite area ratio, 1358 mT in saturation flux density Bm, and 1527 kW/m³ in core loss per unit volume. Thus, according to the test results, the saturation flux density was ensured and the core loss was decreased.

A test example 5A will be explained as follows. In the test example 5 series, ferrite area ratio was increased and aluminum was added. At first, highly pure pig iron, steel, recarburizer, ferrosilicon and metallic aluminum were weighed, and melted at a high frequency melting furnace at 1450-1600° C. The Molten metal was used for forming a test sample by casting. Then, spheroidizing agent 350 g by weight (containing manganese 4.8% by weight, silicon 46% by weight, calcium 2.4% by weight, and balance iron) and ferrosilicon 70 g by weight (containing silicon 70% by weight and balance iron) are contained in a crucible, and covered with iron fillings. The molten metal at 1600° C. was poured into the crucible containing the spheroidizing agent to be spheroidized. After that, the spheroidized molten metal was poured into a cavity of a mold as a forming mold (a self-hardening sand mold, alkali phenol was used as binder). At this time, a pouring temperature of the molten metal was at 1450° C. When the molten metal was poured, inoculant (iron-silicon series) was added to the molten metal. Predetermined time (1 hour) after the molten metal was poured into the mold, the mold was broken for bringing out a solidified cast. The test sample is used without heat treatment.

By above mentioned method, a cast iron series soft magnetic material containing carbon 3.5% by weight, silicon 4.84% by weight, aluminum 2.05% by weight, and residual composed of substantially iron and inevitable impurities is formed. The cast iron series soft magnetic material contains manganese about 0.2-0.6% by weight, and inevitable phosphorous and sulfur. In this case, the cast iron series soft magnetic material includes spheroidal graphite, compacted vermicular graphite (CV graphite), multiform graphite diffused in the ferritic matrix. According to test results, the cast iron series soft magnetic material showed about 95% in ferrite area ratio, 1487 mT in saturation flux density Bm, 1387 kW/m³ in core loss per unit volume.

A test example 5B will be explained as follows. A cast iron series soft magnetic material containing carbon 3.47% by weight, silicon 5.1% by weight, aluminum 2.07% by weight, and residual composed of substantially iron and inevitable impurities was made by similar method to the test example 5A. According to test results, the cast iron series soft magnetic material showed about 96% in ferrite area ratio, 1482 mT in saturation flux density Bm, 1236 kW/m³ in core loss per unit volume. Thus, according to the test results, the saturation flux density was ensured and the core loss was decreased.

A test example 5C will be explained as follows. A cast iron series soft magnetic material containing carbon 3.32% by weight, silicon 4.98% by weight, aluminum 1.54% by weight, and residual composed of substantially iron and inevitable impurities was made by similar method to the test example 5A. According to test results, the cast iron series soft magnetic material showed about 95% of ferrite area ratio, 1484 mT in saturation flux density Bm, and 1477 kW/m³ in core loss per unit volume. Thus, according to the test results, the saturation flux density was ensured and the core loss was decreased.

In the embodiments, the seating groove 61 having the seating surface 60 is formed at the inner circumferential portion 57 of the ring portion 55. A seating groove having a seating surface may be, however, formed at an outer circumferential portion of a rotor body when a rotor is made as an inner rotor. In this case, the seating surface of the seating groove becomes close to a ferrite-rich center portion of the rotor body in thickness direction having good permeability, which has advantage to increase a yoke function. The rotor for the electric rotary machine according to the embodiment of the present invention is applied to the outer rotor of the electric generator as the electric rotary machine. A rotor for an electric rotary machine based on the present invention may be, however, applied to an inner rotor of an electric generator. Further, a rotor for an electric rotary machine may be applied to an outer rotor of a motor as an electric rotary machine, and an inner rotor of a motor as an electric rotary machine. The present invention is not limited to the above-mentioned embodiments, and test examples. Variations can be implemented without deviating from the content of the present invention. Following technical concepts can be construed from the above.

(appendix 1) A method for manufacturing a rotor having a rotor body including a flange portion attached to a rotational shaft and rotated about a rotational axis of the shaft and a ring portion formed at and as a unit with the flange portion for supporting a magnet portion, the method including a casting process with an element for decreasing a cooling rate provided around a cavity portion of a mold for forming the ring portion of the rotor body in order to decrease the cooling rate at the ring portion and increase ferrite area ratio at the ring portion. In this case, ferrite area ratio at the ring portion and permeability of the ring portion can be increased.

(appendix 2) A method for manufacturing a rotor having a rotor body including a flange portion attached to a rotational shaft and rotated about a rotational axis of the shaft and a ring portion formed at and as a unit with the flange portion for supporting a magnet portion, the method including a casting process with an element for increasing a cooling rate provided around a cavity portion of a mold for forming the ring portion of the rotor body in order to increase the cooling rate at a boundary portion between the ring portion and the flange portion and thus increase pearlite area ratio or cementite area ratio at the boundary portion of the ring portion with the flange portion. In this case, pearlite area ratio or cementite area ratio at the boundary portion of the ring portion with the flange portion of the rotor body can be increased. The boundary portion can be utilized as a magnetic resistance portion, which has advantage to reduce a leakage of magnetic flux.

(appendix 3) A member for forming magnetic path made of iron series material as a base material having a portion for forming magnetic path and a magnetic resistance portion for decreasing a leakage of magnetic flux having higher pearlite area ratio or higher cementite area ratio than pearlite area ratio or cementite area ratio of the portion for forming magnetic path.

(appendix 4) A member for forming magnetic path made of iron series material as a base material having an increased ferrite area ratio of a portion for forming magnetic path and an increased pearlite area ratio or cementite area ratio of a magnetic resistance portion for decreasing a leakage of magnetic flux. In appendix 3 and appendix 4, ferrite area ratio of the portion for forming magnetic path has only to be higher than ferrite area ratio of the magnetic resistance portion. As a required basis, ferrite area ratio of the portion for forming magnetic path can be equal to or greater than 40%, equal to or greater than 50%, equal to or greater than 60%, equal to or greater than. 70%, equal to or greater than 80%, equal to or greater than 90%. The magnetic portion has only to have higher pearlite area ratio or higher cementite area ratio than pearlite area ratio or cementite area ratio of the portion for forming magnetic path. As a required basis, pearlite area ratio or cementite area ratio of the magnetic resistance portion can be equal to or greater than 40%, equal to or greater than 50%, equal to or greater than 60%, equal to or greater than 70%, equal to or greater than 80%, equal to or greater than 90%. A method for obtaining pearlite area ratio or cementite area ratio is similar to the method for obtaining ferrite area ratio previously mentioned. Accordingly, pearlite area ratio indicates an area ratio occupied by pearlite in the 2-dimensional cross-sectional surface of the matrix. The matrix does not include an area of graphite. Accordingly, in case that carbide such as vanadium carbide, tungsten carbide, molybdenum carbide, and titanium carbide are formed with graphite, an area of these carbides and graphite are subtracted from a viewing area. A remaining area is considered as the matrix. Ferrite area ratio indicates an area occupied by ferrite in the matrix considered as 100%.

The present invention can be utilized as a component of a magnetic circuit such as an outer rotor or an inner rotor for an electric rotary machine.

The present invention provides a rotor for an electric rotary machine having a rotor body, which can ensure magnetic flux density and reduce core loss. The electric rotary machine is advantageous for improving performance thereof.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the sprit of the present invention. Accordingly, it is expressly intended that all such variations, changes and equivalents which fall within the spirit and scope of the present invention as defined in the claims, be embraced thereby.

1. A rotor for an electric rotary machine, comprising:
a rotatable rotor body;
a plurality of magnet portions provided at the rotor body in circumferential direction with a certain interval; and
a supporting portion provided at the rotor body for supporting the plurality of the magnet portions, wherein
at least the supporting portion of the rotor body is made of ferritic cast iron as base material.

2. The rotor for the electric rotary machine according to claim 1, wherein
ferrite area ratio of the supporting portion of the rotor body is higher than that of the other portion of the rotor body.

3. The rotor for the electric rotary machine according to claim 1, wherein
the rotor body includes an attaching portion attached to a rotational shaft of the electric rotary machine and rotatable about a rotational axis of the shaft and a ring portion integrally provided with the attaching portion and coaxial with the rotational axis, and wherein the ring portion includes the supporting portion of the rotor body and at least the supporting portion of the ring portion is made of the ferritic cast iron as base material.

4. The rotor for the electric rotary machine according to claim 3, wherein
an average thickness of the ring portion is thicker than that of a boundary portion of the ring portion with the attaching portion of the rotor body.

5. The rotor for the electric rotary machine according to claim 1, wherein
ferrite area ratio of the supporting portion of the rotor body is equal to or greater than 40%.

6. The rotor for the electric rotary machine according to claim 1, wherein
the ferritic cast iron of the rotor body contains diffused graphite which is composed of at least any one of spheroidal graphite, compacted vermicular graphite, graphite flake, lump graphite, multiform graphite, rosette form graphite, and eutectic graphite.

7. The rotor for the electric rotary machine according to claim 1, wherein
the ferritic cast iron of the rotor body contains boron or aluminum or combination thereof.

8. The rotor for the electric rotary machine according to claim 1, wherein
carbide produced by an element used for producing carbide is diffused in a ferritic matrix of the ferritic cast iron of the rotor body.

9. The rotor for the electric rotary machine according to claim 8, wherein
the element used for producing carbide includes at least one of vanadium, tungsten, molybdenum, and titanium, and wherein the carbide includes at least one of vanadium carbide, tungsten carbide, molybdenum carbide, and titanium carbide.

10. The rotor for the electric rotary machine according to claim 1, wherein
the ferritic cast iron of the rotor body contains silicon 1.0-12% by weight and carbon 1.5-4.6% by weight.

11. The rotor for the electric rotary machine according to claim 3, wherein
ferrite area ratio of the supporting portion of the rotor body is higher than that of a boundary portion of the ring portion with the attaching portion of the rotor body.

12. The rotor for the electric rotary machine according to claim 3, wherein
the ferritic cast iron contains pearlite; and
pearlite area ratio of a boundary portion of the ring portion with the attaching portion of the rotor body is higher than that of the supporting portion of the rotor body.

13. The rotor for the electric rotary machine according to claim 3, wherein
the ferritic cast iron contains cementite; and
cementite area ratio of a boundary portion of the ring portion with the attaching portion of the rotor body is higher than that of the supporting portion of the rotor body.

14. The rotor for the electric rotary machine according to claim 1, wherein
ferrite area ratio of the supporting portion of the rotor body is equal to or greater than 90%.

15. The rotor for the electric rotary machine according to claim 1, wherein
ferrite area ratio of the supporting portion of the rotor body is equal to or greater than 95%.

16. The rotor for the electric rotary machine according to claim 7, wherein
the ferritic cast iron of the rotor body contains boron 0.01-2% by weight.

17. The rotor for the electric rotary machine according to claim 7, wherein
the ferritic cast iron of the rotor body contains aluminum 0.005-8% by weight.

18. The rotor for the electric rotary machine according to claim 8, wherein
the ferritic cast iron of the rotor body contains the element for producing carbide 0.1-6% by weight.

19. The rotor for the electric rotary machine according to claim 10, wherein
a weight ratio of silicon and carbon contained in the ferritic cast iron of the rotor body is equal to or greater than 0.95.

20. The rotor for the electric rotary machine according to claim 10, wherein
carbon equivalent value of the ferritic cast iron of the rotor body is equal to or greater than 2, wherein
the carbon equivalent value is defined by
carbon equivalent value=the amount of carbon (by weight %)+the amount of silicon (by weight %)×⅓.
